(19) United States
(12) Patent Application Publication
(10) Pub. No.: US 2006/0099412 A1
(43) Pub. Date: May 11, 2006

(54) Masking tape with stencil and method of use

(76) Inventor: Peggy Starr Ross, Collegeville, PA (US)

Correspondence Address: MONTE & MCGRAW, PC, 4092 SKIPPACK PIKE, P.O. BOX 650, SKIPPACK, PA, 19474, US

(21) Appl. No.: 11/262,169

(22) Filed: Oct. 28, 2005

Related U.S. Application Data
(60) Provisional application No. 60/625,279, filed on Nov. 5, 2004.

(51) Int. Cl. B05D 5/00; B32B 37/00; B32B 7/12; B32B 38/10

(52) U.S. Cl. 428/343; 427/282; 427/256; 156/250; 156/247

(57) ABSTRACT

Stenciling for use in home decoration of walls or other surfaces. An extended length of stencil masking tape (100) is provided with an array of cutouts (120) therein, and has a weak adhesive (116) on a back surface (114) for adhering to a surface (150), whereafter paint or other marking material may be applied to the cutout areas. The masking tape (100) is then removed from the surface (150) and discarded, simultaneously removing excess paint and leaving painted surface portions (154) in the shape of the cutouts. The stencil masking tape (100) may be provided rolled onto a cylindrical body (102) for convenience in handling. A method of using such a stencil masking tape is disclosed, and the stencil masking tape may be used in conjunction with a second such stencil masking tape (100′) that is applicable to the stencil-painted surface to enable additional painting such as with another paint color and where the second masking tape has differently shaped cutouts (120′;220′;320). The stencil masking tape (300) may also include a nonlinear longitudinal edge (332) for painting a continuous or near-continuous border adjacent to the cutouts.

### CROSS-REFERENCE TO RELATED APPLICATION

This application claims priority from U.S. Provisional Application Ser. No. 60/625,279 filed Nov. 5, 2004.

### FIELD OF THE INVENTION

The present invention is in the decorative arts and more particularly regards stenciling.

### BACKGROUND OF THE INVENTION

Room decoration of walls conventionally involves painting or wall papering, as well as adding decorative borders to walls such as along the top of the walls around a room, or along a chair rail, for example. Conventional stenciling products have involved individual plastic sheets with a single cutout design for use in decorating walls or other articles; these sheets are held in place by hand or by tape and sequentially moved along the wall for further painting of the wall. It is also known that individual persons can create their own custom stencils by manually cutting cutouts from a low-tack self liner paper with a craft knife, as discussed on the website: http://familyfun.go.com.

It is also known for wall painters to use masking tape for defining a precisely straight painted edge and counteracting drippage, overspray and splatter, that has a weak adhesive on one side permitting ready removal from a surface after use, in conjunction with painting of a wall, such as along molding, or along door and window frames, or corners; but such masking tape is not provided with cutouts; such a known tape is Scotch® Safe Release™ Painters' Masking Tape, manufactured by 3M, Minneapolis, Minn.

It is desired to provide home decorators with a more convenient stenciling product, one that already contains an array of cutouts.

### SUMMARY OF THE INVENTION

The present invention is a length of stenciled removable masking tape, preferably a continuous extended length provided in roll form on a cylinder. The tape includes a generally elongated planar body having a front surface and an opposing backing surface that includes a releasable adhesive so that the tape is readily removed from a surface after use in a peeling motion. A plurality of stencil cutouts are formed in the body, preferably at pre-determined intervals, and in a repeating pattern; the stencil cutouts allow paint, marker or other suitable marking media to be applied to a surface in the shape of the stencil cutouts. Upon tape removal, the paint or other medium remains on the surface, forming a design in the shape of each stencil cutout. One or both longitudinal edges of the tape may be non-linear, if desired, such as to provide a scalloped painted edge or the like, optionally with the use of additional conventional masking tape adhered to the surface adjacent to the non-linear edge(s). Also, the stenciled masking tape of the present invention may include length markings therealong to assist in precise positioning of the masking tape with respect to a reference.

The present invention also includes a method of using the stenciled masking tape of the present invention. The tape is unrolled from the cylinder and adhered to the surface, with the stencil cutouts exposing a portion of the surface to be decorated, in the shape of each stencil cutout. A marking material, such as paint, is applied to the surface through each stencil cutout. It is expected that excess paint will surround each stencil cutout, but it is applied to the front surface of the body and is removed simultaneously with the used tape. Preferably, after the paint is applied to each stencil cutout, the paint is allowed to dry, whereafter the tape is removed from the surface by peeling the tape from the surface. The method may also include applying a second masking tape having an array of cutouts, either similar to or different from the cutouts of the first masking tape, whereafter paint perhaps of a different color, is again applied, allowed to dry and the second masking tape is removed; and so on; the second cutouts may be positioned on the previously painted designs or may be positioned staggered with respect thereto according to creative choice.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a side elevational view of a roll of stenciled masking tape according to the present invention, with the roll of tape partially unrolled to show a first stencil design formed therein;

FIG. 2 is a top plan view showing the stenciled masking tape of FIG. 1 being removed from a surface after use;

FIG. 3 is an enlarged top plan view of the unrolled portion of a second stenciled masking tape having a second stencil design affixed to the surface, with the second stencil design disposed in between adjacent patterns of the first stencil design;

FIG. 4 is an enlarged top plan view of the unrolled portion of a second stenciled masking tape having a second stencil design affixed to the surface, with the second stencil design disposed over the first stencil design;

FIG. 5 is an enlarged top plan view of a stenciled masking tape according to an alternate embodiment of the present invention;

FIG. 6 is a top plan view of a stenciled masking tape according to another alternate embodiment of the invention; and

FIG. 7 is a top plan view of another embodiment of the present invention.

### DETAILED DESCRIPTION OF THE INVENTION

In the drawings, like numerals indicate like elements throughout. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

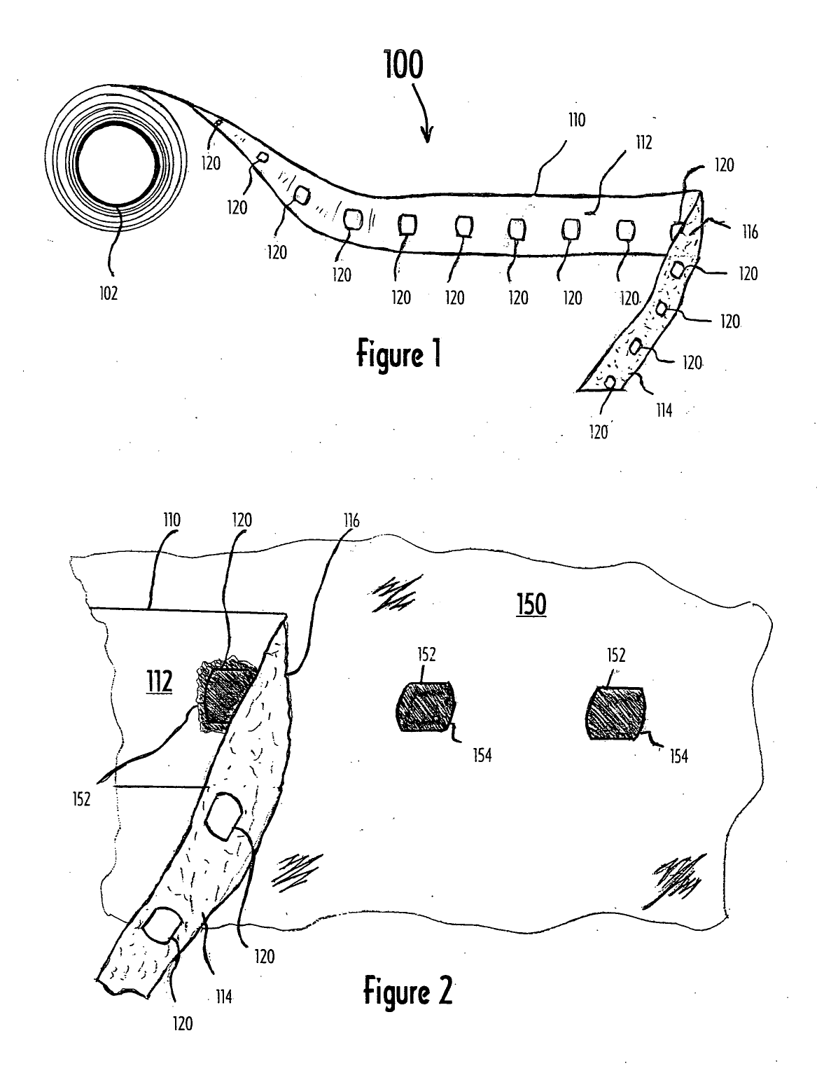

Referring to FIG. 1, a preferred embodiment of a stenciled removable masking tape 100 according to the present invention is shown. The tape 100 is preferably provided in rolled form on a cylinder 102, which is preferably constructed from a cardboard or other suitable, relatively stiff material. The tape 100 is rolled on the cylinder 102 for easy removal from the cylinder 102, and may have a length of 40, 50 or 60 feet. While it is preferred that the stenciled masking tape 100 is an elongated strip of material, those skilled in the art will recognize that the tape 100 may be other shapes, such as in a sheet form cut into discrete convenient lengths, such as 20 feet, and that the cylinder 102 may be omitted. In the event that the cylinder 102 is omitted, a backing sheet (not shown) may be used to mount the tape 100.

The stenciled masking tape 100 includes a generally elongated planar body 110 having a front surface 112 and an opposing backing surface 114. The backing surface 114 includes a releasable adhesive 116 so that the tape 100 is readily removed from a surface after use without causing surface damage. One such product having a suitable releasable adhesive is Scotch® Safe Release™ Painters' Masking Tape, manufactured by 3M. However, those skilled in the art will recognize that other tapes that adhere to a surface, yet are able to be easily removed from the surface in a peeling motion, may also be used. Optionally, the stenciled masking tape of the present invention could be made of transparent material for facilitating accurate tape placement. The masking tape material may also be a vinyl or other polymer or it may be fabric or paper.

A plurality of stencil cutouts 120 are formed in the body 110, preferably at pre-determined intervals, and in a repeating pattern. The stencil cutouts 120 allow paint, marker or other suitable marking medium to be applied to a surface in the shape of the stencil cutouts 120. While a particular shape of stencil cutout 120 is shown in FIG. 1, those skilled in the art will recognize that the stencil cutouts 120 may be other shapes as well.

It is foreseeable that the stencil cutouts also could be more complex and/or larger than the representative simple shapes shown. For example, the cutout design may be a bunch of grapes having a stem and leaves, wherein the marking medium for the grapes may be one color such as purple, and another marking medium such as green may be used later for the stem and leaves, all applied while using the same length of stenciled masking tape. A plurality of marking media may thus be used for a single cutout shape.

Referring to FIG. 2, a method of using the stenciled masking tape 100 will now be described. First, a surface 150 on which to paint, such as a wall, is selected. Although a wall is one medium with which the tape 100 may be used, those skilled in the art will recognize that other surfaces, such as glass, furniture, automobile bodies, or other suitable surfaces onto which the tape 100 may adhere may also be used.

Next, the stenciled masking tape 100 is at least partially unrolled from the cylinder 102 and adhered to the surface 150. The stencil cutouts 120 expose a portion of the surface 150 in the shape of each stencil cutout 120. A marking material, such as paint 152, is applied to the surface 150 through each stencil cutout 120. Excess paint 152 surrounding each stencil cutout 120 usually becomes applied to the front surface 112 of the body 110, as shown on the left hand side of FIG. 2, and is later removed from the wall automatically when the masking tape is removed. Preferably, after the paint 152 is applied to each stencil cutout 120, the paint 152 is allowed to dry. After the paint 152 dries, the tape 100 is removed from the surface 150 by peeling the tape 100 from the surface 150. It is preferred that the tape 100 be removed from the surface 150 within a timeframe specified by the manufacturer of the known tape as referred to above.

The tape 100 is shown in FIG. 2 as being peeled from right to left. The adhesive 116, while sufficiently strong to adhere the body 110 to the surface 150, is sufficiently weak to allow the body 110 to be easily removed from the surface 150 in a peeling motion. As can be seen from the right hand side of FIG. 2, after the tape 100 is removed from the surface 150, the paint 152 remains on the surface 150, forming a design 154 in the shape of each stencil cutout 120.

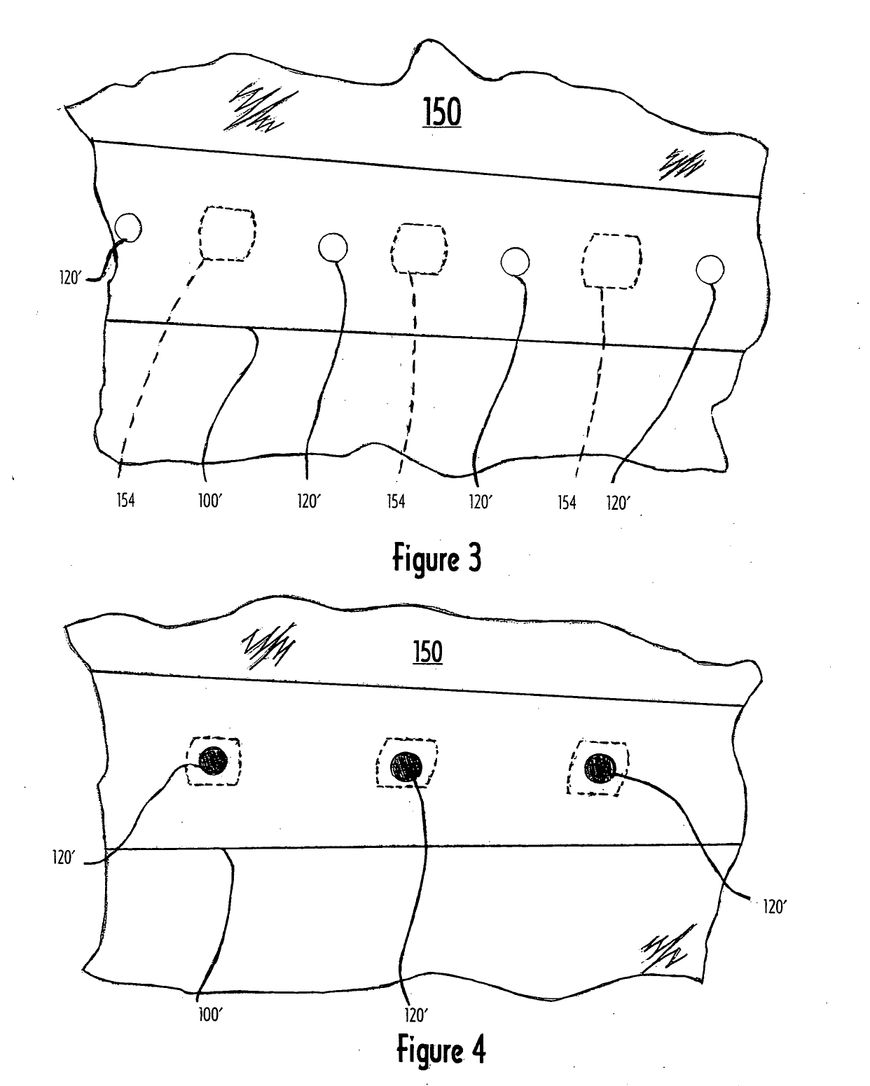

Optionally, as shown in FIG. 3, an additional stenciled masking tape 100′ with a different shape of a stencil cutout 120′ may subsequently be affixed to the surface 150 so that an alternating pattern may be formed between each design 154 on the surface 150. As an alternative option, as shown in FIG. 4, the tape 100′ may be affixed to the surface 150 so that an overlay pattern may be formed on top of each design 154, using a different color than the paint 152 used with the tape 100.

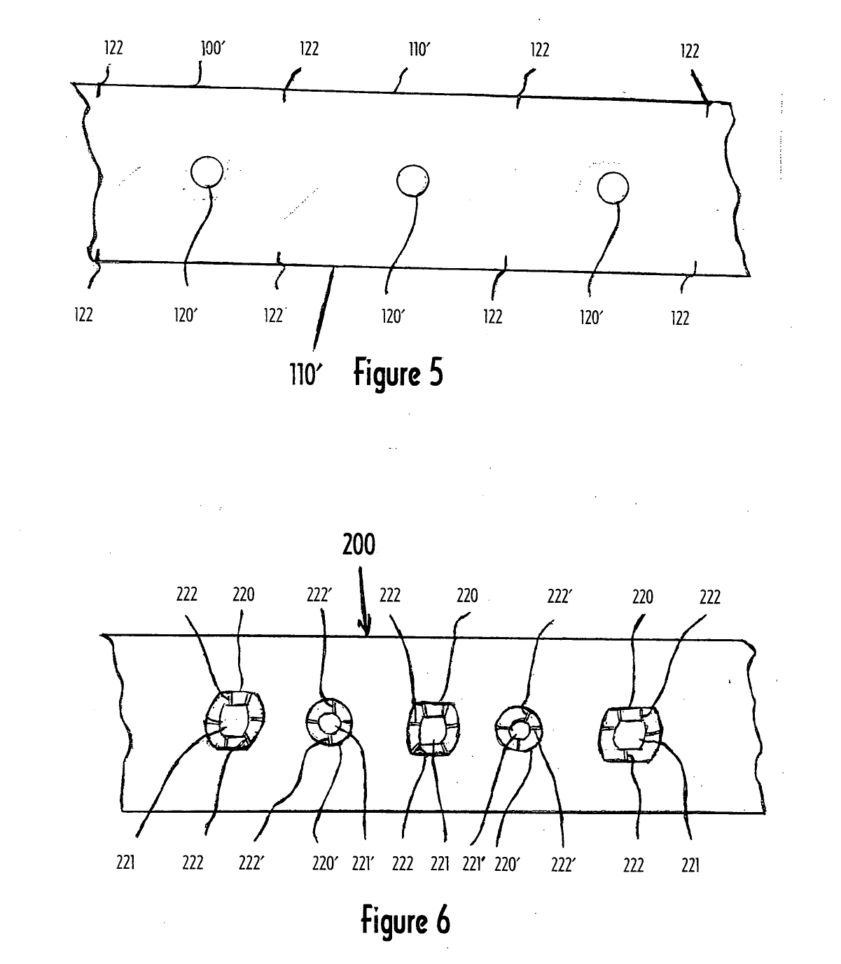

In either of the embodiments describes with respect to FIGS. 1, 3 and 4, the tape 100′ may include indicia 122, such as small measuring tick marks, as shown in FIG. 5, evenly spaced at a selected distance apart along the outer edges of the body 110′, to assist in evenly spacing the stencil cutouts 120′ with respect to the stencil cutouts 120 of the tape of FIG. 1.

Referring now to FIG. 6, an alternate embodiment of a stenciled masking tape 200 is shown. The tape 200 is similar to the tape 100, described above, but with multiple designs of stencil cutouts 220, 220′, to allow a user to select at least one of the multiple designs to use with the tape 200. Additionally, each stencil cutout 220, 220′ may be partially defined, with a remaining portion 221, 221′ of tape material disposed within each cutout 220, 220′ and connected to the main portion of the tape 100 by small connecting pieces 222, 222′ which may be plastic or fabric filaments.

The user may optionally remove the remaining portion 221, 221′ in a particular stencil cutout 220, 220′ as desired to form a desired pattern. Further, with the tape 200, multiple patterns and designs can be formed with a single tape, obviating the need to purchase different tapes 100, 100′ with different designs. Additionally, the remaining portions 221, 221′ of tape material and their respective connecting pieces 222, 222′ may provide additional strength to the tape 200 to reduce the likelihood of ripping the tape 200 while peeling the tape 200 from its roll.

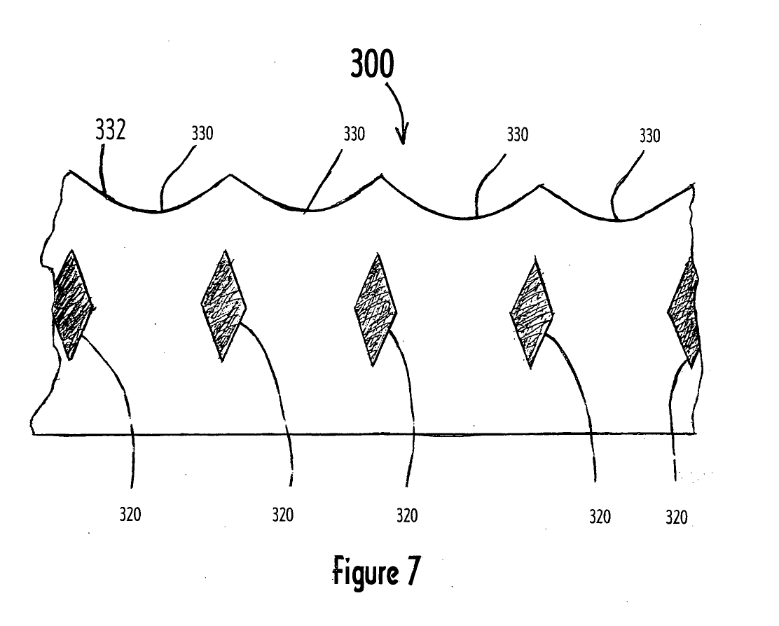

In FIG. 7, another embodiment of the stenciling masking tape is illustrated, wherein stencil 300 includes cutouts 320 in the shape of diamonds, for example, and including a longitudinal edge 332 that is scalloped to provide an array of shallow recesses in which paint may be applied along the stencil edge leaving a scalloped pattern. Preferably, a strip of conventional linear masking tape (or even of stenciled masking tape of the present invention) may be used adjacent and along the scalloped edge 332 upon which excess paint is disposed whereafter both the stencil masking tape and conventional masking tape are removed upon drying of the paint.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A masking tape for stenciling comprising:
a tape body having a front surface and a back surface having a releasable adhesive disposed thereon,
wherein the tape body includes a plurality of stencil cutouts formed therein

2. The masking tape of claim 1 wherein the tape is provided in roll form about a cylindrical tube and is easily unrollable therefrom for application to a surface for stenciling.

3. The masking tape of claim 1 wherein the tape is provided in discrete sheets of preselected cut lengths having removable backing paper thereon that is easily removed to expose the adhesive for adhering to a surface for use.

4. The masking tape of claim 1 wherein at least one longitudinal edge is nonlinear for creating a corresponding decorative nonlinear painted edge.

5. The masking tape of claim 4 wherein the nonlinear edge is scalloped.

6. The masking tape of claim 1 wherein periodic markings are provided along the tape to facilitate precise positioning of the tape body or of a second such tape body.

7. The masking tape of claim 1 wherein the tape body is transparent.

8. A method of stenciling a surface comprising:
providing a masking tape comprising a tape body having a front surface and a back surface having a releasable adhesive disposed thereon, wherein the tape body includes a plurality of stencil cutouts formed therein;
adhering the tape body to the surface;
applying a marking medium to the surface through each of the plurality of cutouts; and
removing the tape body from the surface.

9. The method of claim 7 further including the steps, after removing the tape body from the surface, of:
providing a second masking tape comprising a second tape body having a front surface and a back surface having a releasable adhesive disposed thereon, wherein the second tape body includes a plurality of second stencil cutouts formed therein;
adhering the second tape body to the surface at a preselected position relative to the tape body;
applying a marking medium to the surface through each of the plurality of second cutouts; and
removing the second tape body from the surface.

10. The method of claim 8 wherein the step of adhering of the second tape body includes positioning the plurality of second stencil cutouts with respect to the marked surface resulting from applying the marker to the surface of the tape body.
